(19) United States
(12) Patent Application Publication
(10) Pub. No.: US 2018/0024252 A1
(43) Pub. Date: Jan. 25, 2018

(54) GUIDANCE SYSTEM WITH NAVIGATION POINT CORRECTION

(71) Applicant: AGCO International GmbH, Neuhausen (CH)

(72) Inventors: Theo Vogler, Bad Worishofen (DE); Ludwig Grandl, Olching (DE); Tobias Nothdurft, Immenhofen Ruderatshofen (DE)

(21) Appl. No.: 15/550,849

(22) PCT Filed: Feb. 22, 2016
(86) PCT No.: PCT/US16/18865

§ 371 Date: Aug. 14, 2017

Related U.S. Application Data
(60) Provisional application No. 62/126,743, filed on Mar. 2, 2015.

(51) Int. Cl. G01S 19/51; A01B 79/00; A01B 69/00; G01C 21/00

(52) U.S. Cl. CPC G01S 19/51; G01C 21/005; A01B 79/005; A01B 69/007; A01D 34/86

(57) ABSTRACT

A system comprises a mobile machine including a first portion and a second portion, a positioning receiver coupled with the first portion of the mobile machine, a sensor for determining a position of the first portion of the mobile machine relative to the second portion of the mobile machine, and one or more computing devices. The one or more computing devices are configured to use information from the positioning receiver to determine a geographic location of the positioning receiver, use information from the sensor to determine a position of the first portion of the mobile machine relative to the second portion of the mobile machine, and adjust a navigation point offset according to the position of the first portion of the mobile machine relative to the second portion of the mobile machine, the navigation point offset being a difference in location between the positioning receiver and a navigation point.

### CROSS REFERENCE TO RELATED APPLICATION

This application claims the benefit of U.S. Provisional Application No. 62/126,743 filed Mar. 2, 2015, which is hereby incorporated by reference in its entirety.

### FIELD

Embodiments of the present invention relate to guidance systems for vehicles. More particularly, embodiments of the present invention relate to guidance systems configured to use navigation points defined relative to a positioning receiver.

### BACKGROUND

A global navigation satellite system (GNSS) is a satellite-based electronic navigation system that provides geo-spatial positioning on or near the Earth's surface. Examples of such GNSS systems include the NAVSTAR global positioning system (often referred to simply as “GPS”) operated by the United States and the GLONASS system operated by Russia.

Global positioning may be determined with a GNSS receiver which detects and decodes signals from a number of satellites orbiting the earth. The signals from each of these satellites indicate the position of the satellite and the time at which the signals were sent. The satellite signals may be augmented with additional data to increase the accuracy of GNSS receiver systems. GNSS receivers use the satellite signals, and optionally additional augmentation signals, to calculate latitude, longitude, and altitude of the receiver. This information is often used in vehicle guidance systems to guide a vehicle and direct it to perform certain tasks at a particular position. For example, an agricultural vehicle may be guided to a precise position by a GNSS receiver and commanded to drop a seed at that particular position.

The above section provides background information related to the present disclosure which is not necessarily prior art.

### SUMMARY

A system according to a first embodiment of the invention comprises a mobile machine including a first portion and a second portion, a positioning receiver coupled with the first portion of the mobile machine, a sensor for determining a position of the first portion of the mobile machine relative to the second portion of the mobile machine, and one or more computing devices. The one or more computing devices are configured to use information from the positioning receiver to determine a geographic location of the positioning receiver, use information from the sensor to determine a position of the first portion of the mobile machine relative to the second portion of the mobile machine, and adjust a navigation point offset according to the position of the first portion of the mobile machine relative to the second portion of the mobile machine, the navigation point offset being a difference in location between the positioning receiver and a navigation point.

A system according to another embodiment of the invention comprises a mobile machine including three or more portions, each of the portions configured to shift relative to each of the other portions, a positioning receiver coupled with one of the three or more portions of the mobile machine, one or more sensors for determining the relative positions of the three or more portions of the mobile machine, and one or more computing devices. The one or more computing devices are configured to use information from the positioning receiver to determine a geographic location of the positioning receiver, use information from the one or more sensors to determine the relative positions of the three or more portions of the mobile machine, and adjust a navigation point offset according to the relative positions of the three or more portions of the mobile machine, the navigation point offset being a difference in location between the positioning receiver and a navigation point.

A method according to yet another embodiment of the invention comprises automatically determining a geographic location of a positioning receiver, the positioning receiver being coupled with a first portion of a mobile machine, and automatically determining a position of the first portion of the mobile machine relative to the second portion of the mobile machine. A navigation point offset is automatically adjusted according to the position of the first portion of the mobile machine relative to the second portion of the mobile machine, the navigation point offset being a difference in location between the positioning receiver and a navigation point, and automatically guiding the mobile machine using the navigation point.

These and other important aspects of the present invention are described more fully in the detailed description below. The invention is not limited to the particular methods and systems described herein. Other embodiments may be used and/or changes to the described embodiments may be made without departing from the scope of the claims that follow the detailed description.

### DRAWINGS

Embodiments of the present invention are described in detail below with reference to the attached drawing figures, wherein:

FIG. 1a is a front elevation diagram of a tractor including a positioning receiver, guidance system, operator cabin, and a suspension system associated with the operator cabin.

FIG. 1b is a side elevation diagram of the tractor of FIG. 1a.

FIGS. 2a and 2b illustrate the tractor of FIG. 1 with the operator cabin shifted on the suspension system.

FIG. 3 is a plan view of the tractor of FIG. 1, illustrating a desired travel path and incorrect travel paths resulting from inaccuracies in the guidance system caused by the shifting of the operator cabin.

FIGS. 4a and 4b illustrate the tractor of FIG. 1 including sensors for detecting a shift in the operator cabin relative to the tractor's chassis.

FIG. 5 is front elevation diagram of a tractor similar to the tractor of FIG. 1, but including a suspension system between the chassis and an axle in addition to the suspension system between the operator cabin and the chassis.

FIG. 6 is a rear elevation diagram of a sprayer.

FIGS. 7a and 7b illustrate the tractor of FIG. 1 on a sloped ground surface.

FIG. 8a is a front elevation diagram of a harvester.

FIG. 8b is a front elevation diagram of the harvester of FIG. 8a illustrated on a sloped ground surface.

The drawing figures do not limit the present invention to the specific embodiments disclosed and described herein. The drawings are not necessarily to scale, emphasis instead being placed upon clearly illustrating the principles of the invention.

### DESCRIPTION

The following detailed description of embodiments of the invention references the accompanying drawings. The embodiments are intended to describe aspects of the invention in sufficient detail to enable those skilled in the art to practice the invention. Other embodiments can be utilized and changes can be made without departing from the scope of the claims. The following description is, therefore, not to be taken in a limiting sense.

In this description, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the present technology can include a variety of combinations and/or integrations of the embodiments described herein.

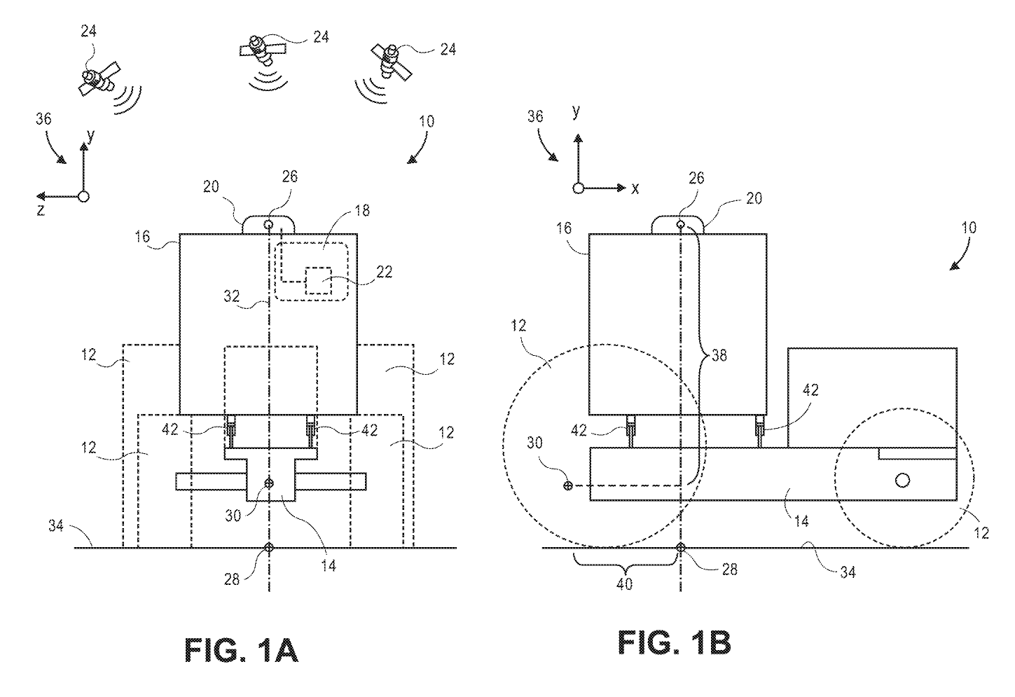

Turning now to the drawing figures, and initially FIGS. 1a and 1b, an exemplary tractor 10 including an automated guidance system is illustrated. The tractor 10 includes wheels 12, a chassis 14 and an operator cabin 16. The tractor 10 is equipped with an automated vehicle guidance system 18 operable to determine a geographic location of the tractor 10 and automatically guide the tractor 10 along a path. Vehicle guidance system 18 is preferably incorporated as part of the vehicle 10 and can be implemented in hardware, software, firmware or combinations thereof. The vehicle guidance system 18 comprises a position-determining component 20 and at least one computing device 22. The position-determining component 20, which may be mounted on an elevated portion of the vehicle 10 such as a top portion of the operator cabin 16, determines its geographic location as the tractor 10 travels from place to place and generates and communicates corresponding location data to the computing device 22. The position-determining component 20 may be or include a positioning receiver, such as a satellite navigation receiver that works with a global navigation satellite system (GNSS) such as the global positioning system (GPS) primarily used in the United States, the GLONASS system primarily used in the Soviet Union, or the Galileo system primarily used in Europe.

In the illustrated embodiment, the position-determining component 20 is operable to receive navigational signals from a plurality of GNSS satellites 24 and to calculate its geographic location as a function of the signals. The geographic location determined by the component 20 typically corresponds to the location of a satellite signal receiver associated with the component 20. While for practical purposes the location of the position-determining component 20 and the location of the satellite signal receiver (or other positioning receiver) are often identical, the location of the satellite signal receiver will be referred to herein as the receiver position point 26. The receiver position point 26 corresponds to the geographic location of the tractor used by the guidance system 18 unless an offset or adjustment is applied, as explained below.

The position determining component 20 may be placed at or near a top of the vehicle, such as on the top of the cabin 16 of the tractor 10, to maximize satellite signal reception. Placing the position-determining component 20 on top of the vehicle results in a receiver position point 26 corresponding to a geographic location of the top of the vehicle that may be several meters removed from the ground surface or from an implement associated with the tractor 10. Modern precision agriculture relies on positioning with an accuracy of less than one meter and sometimes an accuracy within the range of one or two centimeters, such that using a receiver position point 26 located several meters from the ground surface or from an implement may result in errors in automated guidance. For these reasons, most agricultural applications based on satellite navigation require that the vehicle be guided using a point other than the receiver position point 26. The computing device 22 may apply an offset or adjustment or otherwise transform the location corresponding to the receiver position point 26 to a new location referred to herein as a navigation point. The navigation point is a virtual point used by the guidance system 18 to guide the vehicle along a defined path. For example, algorithms run by vehicle guidance system 18 may control vehicle steering so that the navigation point moves along a defined or desired path.

The navigation point may be defined relative to the receiver position point 26 and may correspond to a location on the ground surface or to a location on the vehicle or on an implement attached to the vehicle. In some applications, it is preferable that the navigation point remain fixed relative to ground engaging elements of the vehicle or implement (such as wheels or tracks) or to machine components that are fixed relative to the ground engaging elements, such as a chassis that is rigidly coupled with the ground engaging elements. Two exemplary navigation points designated by reference numerals 28 and 30 are illustrated in FIGS. 1a and 1b. The first navigation point 28 is situated on the transverse center plane 32 of the vehicle and is positioned at or near the ground surface 34. The location of the first navigation point 28 may be preferred, for example, when the tractor 10 is performing a seeding operation. The navigation point may alternatively be located at or near a draw bar or other portion of a hitch system of the tractor 10, such as the center of the ball of a ball hitch provided for connection with an implement. The second navigation point 30 corresponds to such a location of the hitch system. Navigation points 28 and 30 are but two examples, and other navigation points may be used and are within the ambit of the present invention, including a point aligned with a front or rear axle of the vehicle.

As used herein, “implement” includes mechanisms attached to and supported by mobile machines, such as a combine header supported by a combine or a spray boom supported by a self-propelled sprayer. For navigational purposes, the geographic location of an implement may be more accurate and/or useful than the geographic location of another portion of the mobile machine.

The navigation point may be defined relative to the receiver position point 26 according to a navigation point offset. The navigation point offset may have only a vertical component, such as the first navigation point 28, or may have vertical and horizontal components, such as the second navigation point 30 (having vertical component 38 and horizontal component 40). Any transformation of the navigation point relative to the receiver position point 26 in a longitudinal, vertical and/or transverse direction can be easily calculated and stored in the computing device 22 or other component of the vehicle guidance system 18 depending on the vehicle geometry. Thus, the navigation point offset may be determined once for the tractor 10 (or other vehicle), stored at a location accessible by the computing device 22, and used repeatedly by the computing device 22 to determine the location of the navigation point.

The terms longitudinal direction, vertical direction and transverse direction as used herein refer to the directions defined by the vehicle coordinate system 36 shown in FIGS. 1a and 1b. The longitudinal direction is defined as extending along the “X” axis (i.e., in the driving direction), the vertical direction is defined as extending along the “Y” axis, and the transverse direction is defined as extending along the “Z” axis (perpendicular to the driving direction).

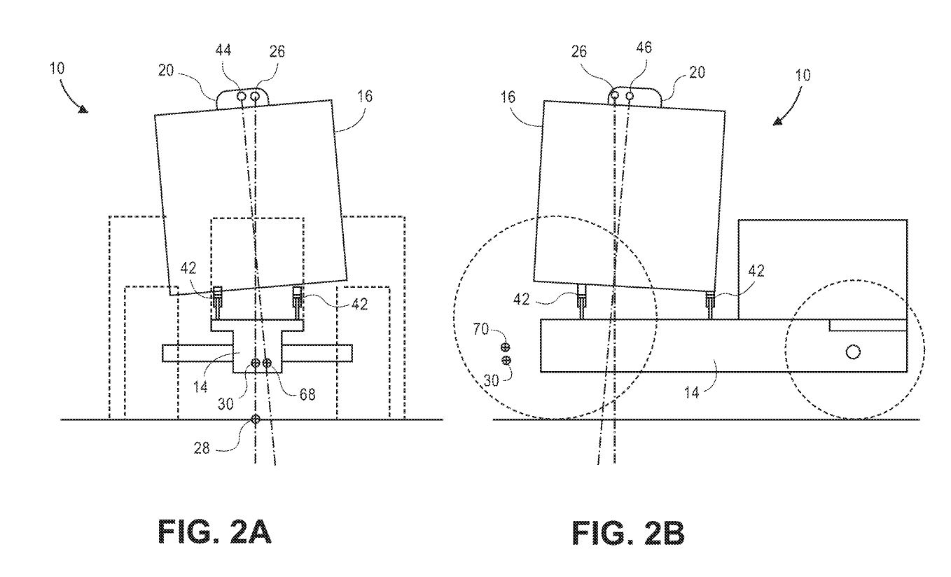

The guidance system described thus far and illustrated in FIGS. 1a and 1b suffers from certain limitations. For example, the navigation point offset, and thus the position of the navigation point relative to the receiver position point 26, is determined under the assumption that the vehicle is a rigid body and the position of the navigation point relative to the receiver position point 26 is constant in all situations. As shown in FIGS. 2a and 2b, however, the operator cabin 16 may be mounted on the vehicle chassis 14 by means of a suspension system including suspension cylinders 42, resulting in movement of the operator cabin 16 relative to the chassis 14 and wheels 12. Because the position-determining component 20 is mounted on the operator cabin 16, movement of the cabin 16 relative to the chassis 14 changes the position of receiver position point 26 and the navigation point calculated from the receiver position point 26. Errors in the location of the navigation point lead to errors in positioning and automated guidance, as explained below.

The position of the second navigation point 30 may be calculated by applying a vertical offset 38 of 2.5 meters and a longitudinal offset 40 of 1.0 meters. In the absence of movement of the operator cabin 16 relative to the chassis 14, the position of the second navigation point 30 can be accurately calculated by applying the vertical offset 38 of 2.5 meters and the longitudinal offset of 1.0 meters to the location corresponding to the receiver position point 26, as explained above. The values associated with this offset may be stored in a memory component associated with the computing device 22 and retrieved by the computing device 22 to convert geographic location information generated by the position-determining component 20 into a geographic location of the navigation point 30. However, if the operator cabin 16 moves relative to the chassis 14 as illustrated in FIGS. 2a and 2b, the receiver position point 26 moves along with it to a transversely deviated point 44, to a longitudinally deviated point 46, or both. If the receiver position point 26 shifts as illustrated in either of FIGS. 2a or FIG. 2b, the navigation point calculated by the computing device 22 using the receiver position point 26 would also shift. As illustrated, the second navigation point 30 may shift laterally to point 68, longitudinally to point 70, or both.

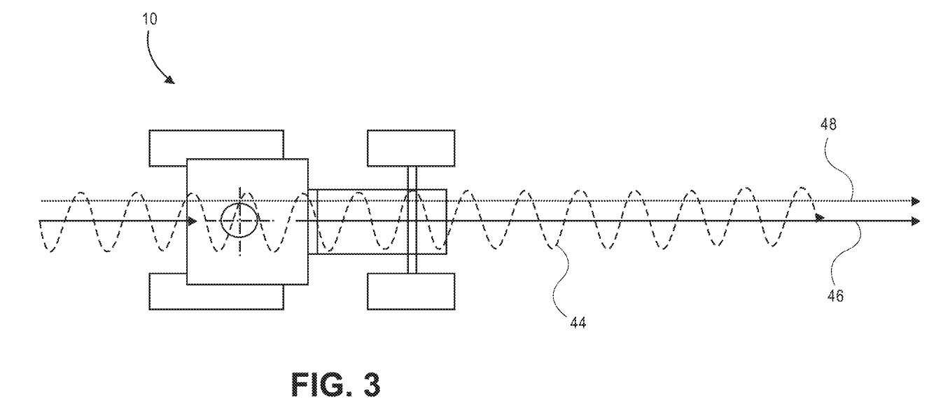

FIG. 3 illustrates possible effects of the shifting of the navigation point. If the navigation point deviation oscillates (also referred to as “dynamic deviation”), such as where the vehicle drives over uneven terrain and the operator cabin 16 repeatedly rolls or pitches about a center or at-rest position, the navigation point may follow an oscillating path 44 rather than a straight planned path 46. Because the vehicle guidance system 18 is programmed to attempt to keep the navigation point on the planned path 46, the deviation of the navigation point from the path 46 may cause the guidance system 18 to steer the machine off the path 46 in an attempt to keep the (oscillating) navigation point on the planned path 46. Such attempts by the guidance system 18 to correct the direction of travel of the tractor may make the situation worse by inducing additional movement in the operator cabin 16. In some situations, the automatic guidance system 18 may not be able to recover without operator intervention.

Also illustrated in FIG. 3 is the effect of a constant deviation of the position of the operator cabin 16 from a normal or at-rest position. This situation may occur, for example, when the vehicle operates on sloped terrain causing the cabin 16 to roll or pitch to a static or quasi-static position remaining constant over a period of time but deviated from a center or level position. Consequently, the navigation point remains offset from a normal or desired position as the tractor 10 travels and the guidance system 18 steers the tractor 10 according to the incorrect position of the navigation point. This results in the vehicle following a more or less straight path 48 that is offset from the planned path 46, causing unworked gaps between worked areas, inaccurate application of chemicals, or similar problems.

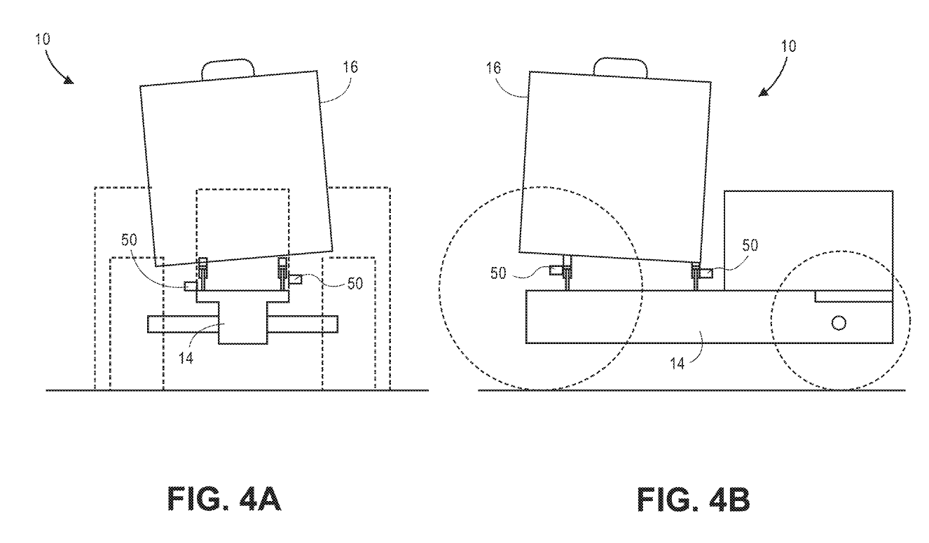

To address the problems discussed above, embodiments of the invention include a system configured to detect and compensate for relative movement of portions of the tractor 10 (or other machine) that may result in inaccurate positioning of a navigation point. In the example of the tractor 10 set forth above, one or more sensors and/or computing devices may be provided to detect shifts in the position of the operator cabin 16 relative to the chassis 14, and to adjust the navigation point offset so that the location of the navigation point remains fixed relative to the chassis 14, even as the operator cabin 16 shifts relative to the chassis 14. FIGS. 4a and 4b illustrate a plurality of sensors 50 associated with the operator cabin suspension system configured to detect movement of the cabin 16 relative to the chassis 14 and to communicate relative movement data to the computing device 22. The computing device 22 uses the relative movement data to dynamically and automatically adjust the navigation point offset so that the navigation point remains in the same location relative to the chassis 14 regardless of the position of the cabin 16.

Prior to operation, the system is calibrated to determine a normal or default navigation point offset. Calibration may involve two steps: 1) determining a normal position of the operator cabin 16, and 2) determining a default navigation point offset corresponding to the normal position of the cabin 16. The normal position of the operator cabin 16 relative to the chassis 14 may be determined when the tractor is stationary on a level ground surface with an operator in the cabin 16. This step may also be performed with an empty cabin 16 if the operator's weight would have minimal impact on the position of the cabin 16 or if an average operator weight is used. If the operator cabin 16 is suspended using hydraulic cylinders, the system may determine the normal position of the operator cabin 16 using sensors that detect a length of each of the hydraulic cylinders or the pressure of hydraulic fluid in a hydraulic circuit associated with the hydraulic cylinders. The default navigation point offset corresponding to the normal position of the operator cabin 16 may be submitted by a user wherein, for example, the user submits to the computing device 22 one or more offset values corresponding to deviations along one or more of the X, Y or Z axes described above.

The system may be calibrated at a factory where the machine is assembled, at a dealership where the machine is sold, and/or on a farm where the machine is operated. Furthermore, calibration may be performed repeatedly, such as each time an operator enters the cabin 16 to account for differences in operator weight.

In operation the computing device 22 receives geographic location information from the position-determining component 20 and determines the geographic location of a navigation point by applying a navigation point offset to the geographic location of the position-determining component 20, as explained above. The vehicle guidance system 18 uses the geographic location of the navigation point to guide the vehicle.

During operation the computing device 22 or other system component monitors the position of the operator cabin 16 relative to the chassis 14 by, for example, receiving data from one or more of the sensors 50. If any one of the suspension cylinders is extended or retracted relative to a normal position, the sensor 50 associated with that cylinder communicates information to the computing device 22 indicating the change in position. The computing device 22 uses the information to adjust the navigation point offset and determines the geographic location of the navigation point by applying the adjusted offset to the receiver position point. It will be appreciated that this compensation process addresses the problems of dynamic deviation caused by cabin oscillation as well as static deviation caused by travel on sloped terrain.

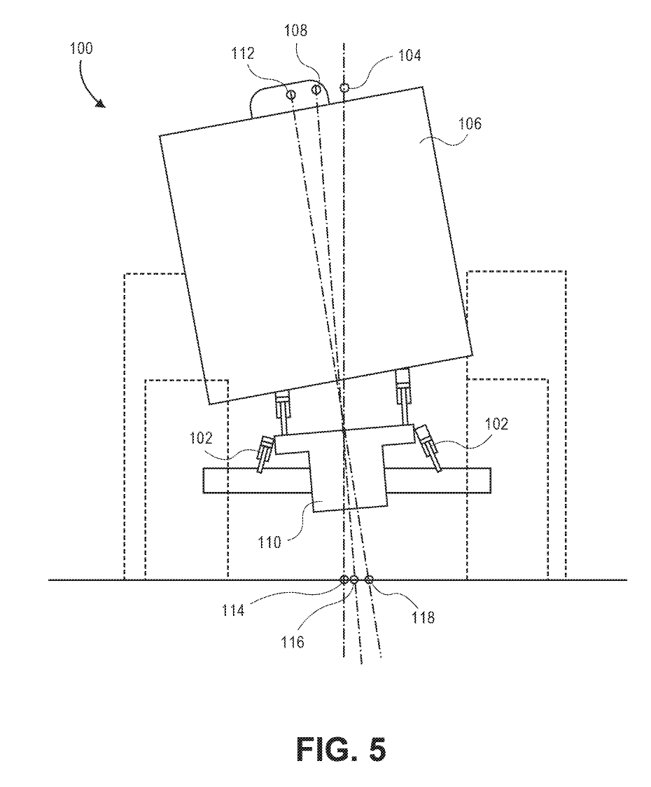

The implementation of the invention discussion above relates to situations where a machine includes a first portion associated with a positioning receiver and a second portion associated with a navigation point, and resolves the problem by detecting and compensating for relative movement between the two portions. The invention may also be used in situations where the relative movement of more than two portions of the machine contribute to inaccuracies in the location of the navigation point. One example of this is the tractor 100 illustrated in FIG. 5 that is equipped with a front axle suspension including suspension cylinders 102. The axle suspension represents an additional source of relative movement between a portion of the vehicle defining a receiver position point 104 (in this case the operator cabin 106) and a desired navigation point. If a tractor is provided with front axle suspension but a rigid rear axle the influence of the axle suspension may be minor compared to the influence of the cab suspension. In tractors with suspension associated with both front and rear axles, however, the problem would be more pronounced.

With continuing reference to FIG. 5, if movement of only the operator cabin 106 is considered, counterclockwise movement of the cabin 106 may result in the receiver position point 104 shifting to a first position 108. If the axle suspension results in counterclockwise rotation of the machine chassis 110, the receiver position point 104 would shift to a second position 112 that is even further removed from the original receiver position point 104. The movement of the receiver position point results in corresponding movement of the navigation point calculated based on the receiver position point. The location of the desired navigation point 114 (corresponding to navigation point 28), for example, would be placed at a first position 116, corresponding to movement of the cabin 16 attributable to the cabin suspension system, or a second position 118 attributable to the cumulative effect of both the cabin suspension system and the chassis suspension system. Thus, relative movement of the operator cabin 16 and the chassis 10 may have a cumulative effect on the error in placement of the navigation point that exacerbates the guidance problems discussed above.

By determining changes in the relative positions of the operator cabin 106 and the chassis 110, the computing device can apply the changes to the navigation point offset so that the navigation point remains in the same position regardless of movement of the operator cabin 106, the chassis 110, or both. Thus, if the desired navigation point corresponds to point 114, it would remain at the location 114 even if the receiver position point shifts to the first position 108 or to the second position 112.

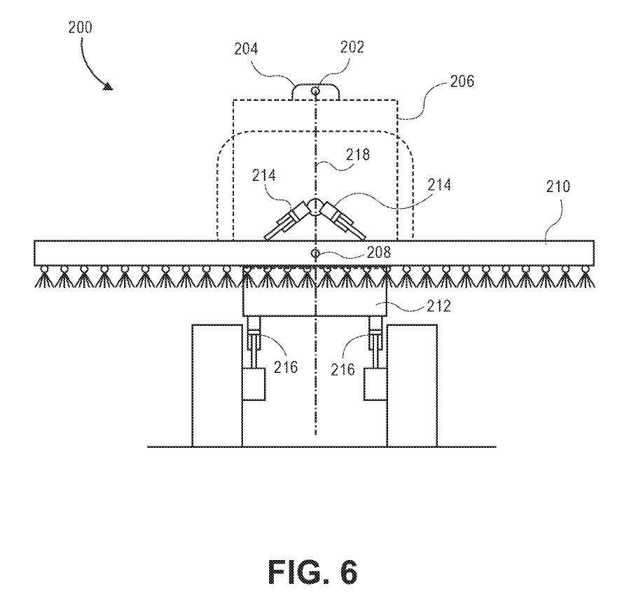

The invention may be used with various types of machines. FIG. 6 illustrates how the invention may be implemented with a sprayer 200 or similar application machine. The sprayer 200 may include an operator cabin 206 with a cabin suspension system (not shown), a chassis 212 with a chassis suspension system 216, and a boom 210 with a boom suspension system 214. The receiver position point 202 may correspond to a position-determining component 204 fixed at or near the top of the cabin 206 while the navigation point 208 may correspond to a center of the spray boom 210.

Similar to the tractor 10, relative movement between the cabin 206 and/or chassis 212 and the boom 210 can be determined by one or more sensors (not illustrated) measuring extension and retraction of suspension cylinders. Comparing the measured values of the suspension system cylinders with default values allows a computing device to calculate a navigation point offset and adjust the location of the navigation point 208 accordingly so that the navigation point 208 rests within a transverse center plane 218 of the sprayer 200.

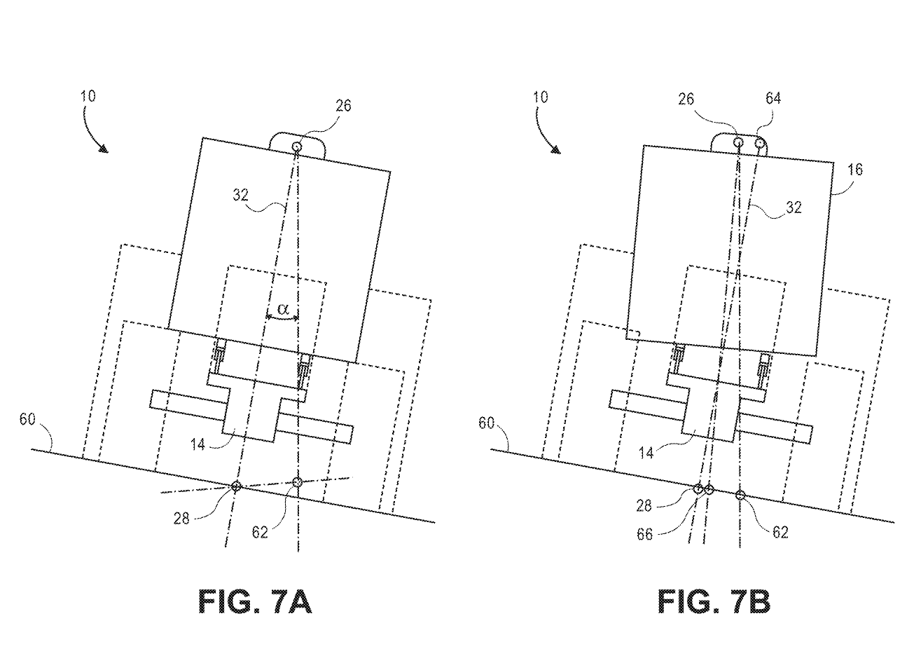

The present invention also improves the accuracy of systems configured to compensate for the effects of sloping terrain. The tractor 10 is illustrated travelling along a sloped ground surface 60 in FIGS. 7a and 7b. If the tractor is treated as though it were rigid, the slope compensation may be determined using the inclination angle a as illustrated in FIG. 7a. The angle a corresponds to the angle of inclination of the ground and, therefore, of the chassis 14. The navigation point can then be moved from the incorrect position 62 to the correct position 28. The corrected navigation point 28 is therefore at or near the ground surface 60.

If the operator cabin 16 is suspended, however, the position of the cabin 16 relative to the chassis must be considered as part of the slope compensation to determine the correct position of the navigation point. Using only standard slope compensation without considering the position of the cabin 16 relative to the chassis 14, the system would not recognize that the receiver position 26 has shifted away from an anticipated location 64 lying on the center plane 32 of the vehicle 10. The invention addresses this situation by detecting movement of the operator cabin 16 relative to the chassis 14, as explained above, so that the position of the navigation point can be adjusted to compensate for movement of the cabin 16 relative to the chassis 14 as well as for the sloped terrain. With particular reference to FIG. 7b, adjusting the navigation point offset to compensate only for the rotation of the operator cabin 16 relative to the chassis moves the anticipated receiver position point 64 to the actual receiver position point 26. Adjusting the navigation point offset to compensate for the sloped ground surface moves the navigation point from an incorrect location 62 or 66 to the correct location 28.

The operator cabin 16 may be supported by an active suspension system configured to shift the cabin 16 toward a level position, as illustrated in FIG. 7b wherein the cabin 16 is rotated counterclockwise (uphill) relative to the chassis 14. Alternatively, the cabin 16 may be supported by a passive suspension system that would result in the cabin 16 rotating clockwise (downhill) relative to the chassis 14. In either scenario sensors associated with the suspension system would detect any change in the position of the cabin 16 relative to the chassis 14. Furthermore, the system may be configured to make adjustments for shifts associated with a chassis suspension system in addition to the sloped ground surface 60 and the cabin 16 suspension system.

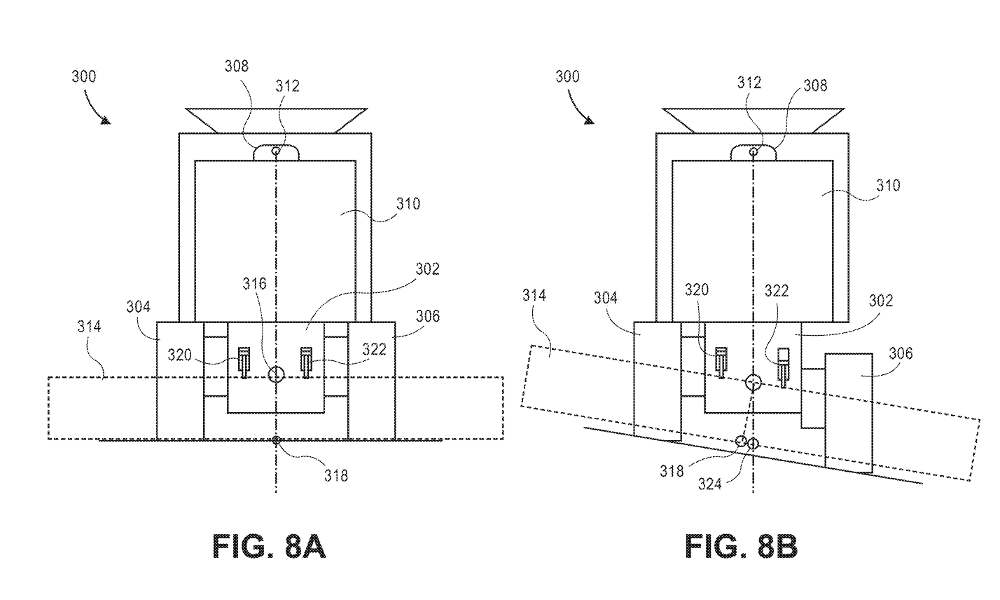

Turning now to FIGS. 8a and 8b, another implementation of the invention is illustrated for use with a combine harvester 300 including a self-leveling chassis 302 configured to compensate for operation on sloped terrain by automatically shifting relative to ground engaging elements (e.g., wheels) to remain in an upright or level position. This functionality not only preserves the comfort of the operator but also serves to maintain the body of the harvester 300 in a horizontal operating position. Operating in a horizontal position is important because the crop processing systems, such as the threshing and cleaning systems, in the harvester 300 may suffer from performance deficiencies when operated in an inclined position.

A self-leveling chassis may be implemented by adjusting the position of the wheels 304, 306 relative to the chassis 302. In the illustrated example, the left wheel 304 is in a raised position relative to the chassis 302 and right wheel 306 is in a lowered position relative to the chassis 302 so that the chassis 302 is level. One example of a self-leveling system is the AUTO LEVEL system sold by AGCO Corporation. The combine header 314 is also configured to pivot about a header pivot point 316 so that it remains parallel with the ground surface.

The position-determining component 308, including a positioning receiver, may be positioned at or near a top of an operator cabin 310 of the harvester 300 and defines a receiver position point 312. The navigation point 318 may correspond to a position relative to the header 314, such as a center of the header 314. As illustrated in FIG. 8b, the location of the navigation point 318 changes relative to the location of the receiver position point 312 in situations where the header 314 is pivoted relative to the chassis 302. The system of the present invention identifies changes in the position of the header 314 relative to the chassis 302 and adjusts the position of the navigation point 318 so that it remains at the desired location relative to the header 314. On level ground the navigation point may be positioned directly below the chassis 302, as illustrated in FIG. 8a. On a sloped surface, however, the same location below the chassis 302, indicated by reference numeral 324, is not the correct position of the navigation point 318 relative to the header 314.

A first method of determining the navigation point 318 involves detecting the position of the wheels 304, 306 relative to the chassis 302 and adjusting the navigation point based on wheel position. This method may be desirable where the position of the header 314 follows the position of the wheels 304, 306 relative to the chassis 302. A second method of determining the navigation point 318 involves detecting the length of each of the header lift cylinders 320, 322.

Although the invention has been described with reference to the preferred embodiment illustrated in the attached drawing figures, it is noted that equivalents may be employed and substitutions made herein without departing from the scope of the invention as recited in the claims. The tractor 10 may include multiple computing devices, for example, that cooperate to perform the functions of the computing device 22 described above.

Having thus described the preferred embodiment of the invention, what is claimed as new and desired to be protected by Letters Patent includes the following:

1. A system comprising:
a mobile machine including a first portion and a second portion;
a positioning receiver coupled with the first portion of the mobile machine;
a sensor for determining a position of the first portion of the mobile machine relative to the second portion of the mobile machine; and
one or more computing devices configured to
use information from the positioning receiver to determine a geographic location of the positioning receiver,
use information from the sensor to determine a position of the first portion of the mobile machine relative to the second portion of the mobile machine, and
adjust a navigation point offset according to the position of the first portion of the mobile machine relative to the second portion of the mobile machine, the navigation point offset being a difference in location between the positioning receiver and a navigation point.

2. The system as set forth in claim 1, the one or more computing devices further configured to determine a geographic location of the navigation point by adjusting the geographic location of the positioning receiver according to the navigation point offset.

3. The system as set forth in claim 1, the one or more computing devices further configured to automatically guide the mobile machine using the navigation point.

4. The system as set forth in claim 1, the first portion of the machine being an operator cabin configured to shift relative to the second portion of the machine.

5. The system as set forth in claim 1, the second portion of the machine being a ground-engaging portion.

6. The system as set forth in claim 1, the second portion of the machine being an implement.

7. The system as set forth in claim 1, wherein the machine is a harvester, the first portion is an operator cabin and the second portion is a header.

8. The system as set forth in claim 1, wherein the machine is a harvester, the first portion is a machine chassis and the second portion is a header.

9. The system as set forth in claim 1, wherein the machine is a tractor, the first portion is an operator cabin and the second portion is a chassis.

10. The system as set forth in claim 1, the one or more computing devices further configured to adjust the navigation point offset to compensate for the effects of sloped terrain.

11. A system comprising:
a mobile machine including three or more portions, each of the portions configured to shift relative to each of the other portions;
a positioning receiver coupled with one of the three or more portions of the mobile machine;
one or more sensors for determining the relative positions of the three or more portions of the mobile machine; and
one or more computing devices configured to
use information from the positioning receiver to determine a geographic location of the positioning receiver,
use information from the one or more sensors to determine the relative positions of the three or more portions of the mobile machine, and
adjust a navigation point offset according to the relative positions of the three or more portions of the mobile machine, the navigation point offset being a difference in location between the positioning receiver and a navigation point.

12. The system as set forth in claim 11, the one or more computing devices further configured to determine a geographic location of the navigation point by adjusting the geographic location of the positioning receiver according to the navigation point offset.

13. The system as set forth in claim 11, the one or more computing devices further configured to automatically guide the mobile machine using the navigation point.

14. The system as set forth in claim 11, the first portion of the mobile machine including an operator cabin, the second portion of the mobile machine including a vehicle chassis, and the third portion of the mobile machine including a ground engaging element.

15. The system as set forth in claim 11, the first portion of the mobile machine including an operator cabin, the second portion of the mobile machine including a vehicle chassis, and the third portion of the mobile machine including an implement.

16. A method comprising:
automatically determining a geographic location of a positioning receiver, the positioning receiver being coupled with a first portion of a mobile machine;
automatically determining a position of the first portion of the mobile machine relative to the second portion of the mobile machine;
automatically adjusting a navigation point offset according to the position of the first portion of the mobile machine relative to the second portion of the mobile machine, the navigation point offset being a difference in location between the positioning receiver and a navigation point; and
automatically guiding the mobile machine using the navigation point.
